(19) United States
(12) Patent Application Publication
(10) Pub. No.: US 2021/0119404 A1
(43) Pub. Date: Apr. 22, 2021

(54) DEVICE FOR ADJUSTING AN OPTICAL COMPONENT

(71) Applicant: Compact Laser Solutions GmbH, Berlin (DE)

(72) Inventor: Andreas Kuntze, Berlin (DE)

(21) Appl. No.: 16/762,299

(22) PCT Filed: Nov. 8, 2018
(86) PCT No.: PCT/EP2018/080601

§ 371 Date: May 7, 2020

(30) Foreign Application Priority Data
Nov. 9, 2017 (DE) 10 2017 126 293.8

(51) Int. Cl. H01S 3/11; H01S 3/02; H01S 3/109; H01S 3/10

(52) U.S. Cl. CPC H01S 3/11; H01S 3/10084; H01S 3/109; H01S 3/027

(57) ABSTRACT

The present invention relates to an adjustment device for adjusting an optical component in a device for generating laser radiation, which comprises an adjuster, a coupling element and a guiding device. The coupling element is coupled to the adjuster and the guiding device and the guiding device is coupled to the optical component. The adjustment device is capable of changing the position of the optical component, wherein two of the elements (4, 5, 6) of the adjustment device (4) are coupled by magnetic power transmission. Arrangements of this kind make possible to provide laser beam sources which stand out by a particular long lifetime, in particular in the field of high-energy radiation.

### CROSS-REFERENCE TO RELATED APPLICATION(S)

This application is a Section 371 National Stage Application of International Application No. PCT/EP2018/080601, filed on Nov. 8, 2016, entitled “DEVICE FOR ADJUSTING AN OPTICAL COMPONENT”, which published as WO 2019092099 A1, on May 16, 2019, and claims priority to German Patent Application No. 102017126293.8, filed on Nov. 9, 2017, the disclosures of which are incorporated herein by reference in their entireties.

### TECHNICAL FIELD

The invention relates to an adjustment device for adjusting an optical component, a device for generating laser radiation comprising an adjustable optical component, as well as a method for adjusting an optical component.

### BACKGROUND

High-energy UV lasers are widely used in science and technology, e.g., for micro material processing, marking, semiconductor processing, manufacturing of solar cells, structuring of ITO and TCO layers, glass and ceramics processing and many other things. Optical components such as mirrors, prisms, gratings, but also non-linear optical crystals for generating the higher harmonics, which are exposed to the intensive laser radiation being rich of energy, are subject to a degradation of the used materials and thus a deterioration of their optical properties. On the one hand, dust particles can burn into the components and, e.g., reduce or completely destroy the reflectance of mirrors. On the other hand, the surfaces of the non-linear optical crystals can be changed chemically in such a manner that an effective conversion of the primary laser radiation is no longer present. The consequence is a reduced efficiency of the laser. This deterioration of the efficiency of the optical components is basically restricted to the diameter of the laser beam, which is normally between 1 nm and 1000 nm. In technology there exist methods for increasing the lifetime of the optical components and thus maintaining the efficiency of the laser system.

U.S. Pat. No. 8,885,246 B2 relates to a device for turning or rotating optical components of one or more plane-parallel optical plates so that in the non-linear optical crystal other spots in which the performance is not reduced are penetrated by the laser radiation. U.S. Pat. No. 5,825,562 describes a mechanical system in which an optical component is continuously rotated by a motor in such a manner that the optical component follows a rotating spiral path. These movements can be controlled by a computer program as described, e.g., in U.S. Pat. No. 6,859,335 B1.

### SUMMARY

The methods presented herein have disadvantages. Only one optical component can be adjusted at a time. For increasing the lifetime of a plurality of components, the adjustment device must be attached to each optical component. Often it is desirable to accommodate the optical components in a protective housing and evacuate the air remaining in the housing or flush it with purified air or gases in order to reduce, e.g., the lifetime-reducing degassing products of other components and dust particles of the optical system. The mechanical system necessary for the adjustment device is then also accommodated in the housing, can degas and contaminate the optical components. This is important in particular for the lifetime of laser systems operating in the UV range and adjacent wavelengths. Moreover, the adjustment device must be fine-adjusted at and with each optical component. The methods presented herein for increasing the lifetime of optical components in a laser system are also involved in view of mounting and operation and, therefore, cost-intensive.

Therefore, it is an object of the present invention to provide an adjustment device, a device for generating laser radiation as well as a corresponding method, which lead to an increased lifetime of the system, the design of which is compacter, and which is consequently more cost-efficient and can be handled more easily than solutions known so far.

The object is achieved by an adjustment device according to the independent claim.

The adjustment device according to the invention is configured such that the position of the optical component can be changed by it. The adjustment device comprises an adjuster, a coupling element and a guiding device for a linear movement. The optical component to be adjusted is coupled to the guiding device which is coupled to the adjuster by means of the coupling element. Two elements of the adjustment device are coupled by magnetic power transmission. In an embodiment, the coupling element is configured as a magnet and the adjuster and/or the guiding device or components permanently connected thereto consist of ferromagnetic or magnetic materials. The adjuster is used for adjusting the coupling element which adjusts the optical component linearly and/or rotationally by means of the guiding device. Due to the magnetic coupling, the mechanical system used in the adjustment device according to the invention is simple, robust and thus can be manufactured in a cost-efficient manner and can be easily retrofitted in already existing devices for generating laser radiation. Optical components in the meaning of the present invention are, for example, frequency conversion devices which can comprise one or more crystals, mirrors, gratings, optically parametric oscillators (OPO), Brewster windows and further components which can be subject to a process leading to a decrease in the efficiency in the area to which the laser radiation is applied in the course of operation. These components can moreover be combined to assemblies by means of which a plurality of components combined to this assembly can be moved by means of one adjustment device. An assembly of this kind can also be arranged in a chamber which, in a further option, can be closed in an airtight manner in order to prevent contamination inside the chamber. It is a further advantage of the invention that very cost-efficient components of the adjustment device can be used because they can be arranged outside the chamber. The components arranged outside the chamber do not have to meet the same high requirements as regards degassing and contamination as the components arranged inside the chamber. The adjustment device can also include a rolling bearing and/or a ball bearing. Moreover, linear movements and/or rotational movements can be made by means of the adjustment device.

Further developments of the invention relating to the device for adjusting are discussed in the dependent claims.

In an advantageous embodiment of the invention, the adjustment device comprises a sealed chamber in which the optical component to be adjusted is arranged. This sealed chamber protects the optical component from degassing, for example from plastics, adhesives and lubricants, and from contamination which can reduce the optical quality of the optical component and thus the performance of the device for generating laser radiation.

In a further embodiment of the invention, the adjuster is arranged outside the chamber. The mechanical system for adjusting the optical component is outside the chamber in which the optical components are arranged. Thus, relatively few components which can degas and contaminate the optical components are within the chamber. Only a coupling element which connects the adjuster and the guiding device by magnetic forces projects into the chamber. The operating element for adjusting the optical components is outside the chamber and, therefore, easily accessible.

In a further embodiment of the invention, the guiding device is arranged inside the sealed chamber. The guiding device serves for a directed movement of the optical component.

In a further embodiment of the invention, the adjustment device comprises an intermediate element. The intermediate element is positioned between the coupling element and the guiding device and magnetically coupled to the two components. The intermediate element serves for compensating for the play between the coupling element and the guiding device and/or for compensating for the offset when the adjustment direction of the coupling element and that of the optical component are not exactly parallel.

In a further aspect of the invention, the sealed chamber has an opening. In a further embodiment of the invention, an element of the adjustment device is guided through this opening of the sealed chamber.

In an advantageous embodiment of the invention, the adjustment device according to the invention comprises a seal which closes the space between the edge of the opening of the sealed chamber and the element of the adjustment device guided through the opening. This seal protects the optical component to be adjusted and arranged in the sealed chamber and thus extends its lifetime. The sealed chamber can also be evacuated or flushed in order to remove the lifetime-reducing contaminants (e.g. degassing products and/or dust) to a large extent from the sealed chamber.

In a further embodiment of the invention, the element of the adjustment device guided through the opening of the sealed chamber is a pin. In a further embodiment of the invention, the element of the adjustment device guided through the opening of the sealed chamber and the coupling element have contact surfaces by means of which the coupling element and the element of the adjustment device guided through the sealed chamber are connected to each other. If the movement direction of the coupling element and that of the element guided through the opening of the sealed chamber are not exactly parallel, there is a lateral offset. The coupling element and/or the element guided through the opening of the sealed chamber then slide on the contact surfaces in a manner lateral to the movement direction of the adjustment.

In a further embodiment of the invention, the element of the adjustment device guided through the sealed chamber and the coupling element are connected with each other by means of the contact surfaces so as to be laterally movable. If the movement direction of the coupling element and that of the element guided through the opening of the sealed chamber are not exactly parallel, there is a lateral offset. The coupling element and/or the element guided through the opening of the sealed chamber then slide on the contact surfaces. This is in particular important in connection with optical components to be fine-adjusted in order to compensate for fine-adjustment movements.

In a further embodiment of the invention, the diameter of the contact surfaces of the element of the adjustment device guided through the sealed chamber and/or that of the coupling element is larger than the lateral play of the guiding device. The diameter of the contact surfaces of the element of the adjustment device guided through the opening of the sealed chamber and that of the coupling element are different in accordance with a further aspect of the invention.

In a further embodiment of the invention, two elements of the adjustment device are coupled by a transmission of the magnetic forces through a wall of the sealed chamber. An opening in the sealed chamber for adjusting the optical component is not necessary in this arrangement. Adjustment is realized by the adjuster by the magnetic coupling of the coupling element and the element guided through the opening of the sealed chamber.

The object of the invention is moreover achieved by a device for generating laser radiation according to the independent method claim.

The device for generating laser radiation comprises a resonator which generates the primary laser radiation and at least one optical component. The optical component is adjustable by means of the adjustment device. In this manner, any desired undamaged spot on the optical component can be searched for and adjusted in the beam path of the resonator. This new position on the surface of the component has so far not been arranged in the beam path of the laser radiation and therefore has not yet been used. The lifetime of the optical component is clearly increased.

Further developments of the device for generating laser radiation according to the invention are discussed in the dependent method claims.

In a further embodiment of the invention, the position of the beam path is not changed by adjusting the optical component from a first position to a further position relative to the resonator. Because of this advantageous arrangement, it is not necessary to newly fine-adjust the optical component after adjustment. Before putting the device for generating laser radiation into operation, it is only necessary to fine-adjust the adjustment device together with the optical component.

In a further advantageous embodiment of the invention, the optical component is part of an optical assembly which comprises one or more optical components, e.g. frequency-converting crystals, mirrors, lens, prism, OPO and combinations thereof and therefore lies in the beam path of the laser radiation generated by the resonator. At least one optical component is configured such that it is suitable for deflecting the primary laser radiation generated by the resonator. The optical assembly moreover comprises a movably arranged support element on which the device for deflecting the laser radiation is arranged.

In a further embodiment of the invention, the optical assembly is configured such that it comprises a device for converting the frequency of the laser radiation. For generating laser radiation in the UV range, normally the laser beam is focused into a non-linear crystal, e.g. LBO, BBO, KTP etc. By the high intensity of the laser radiation in a small area (beam diameter normally about 1 μm to 1000 μm), the non-linear crystal can be altered irreversibly in the target area of the laser beam and its mode of action can be affected considerably. By means of the adjustment device of the optical assembly, the device for converting the frequency is adjusted by an amount so that the laser beam is directed through an undamaged or previously unused area of the frequency conversion device without the position and/or direction of the beam path being changed at the beam outlet.

The object of the invention is moreover achieved by a method according to the independent claim.

In accordance with the method for adjusting an optical component in a device for generating laser radiation according to the invention, the position of the optical component is changed. The optical component is coupled to a guiding device. The adjuster is coupled to the guiding device by means of a coupling element, wherein the power is transmitted magnetically between the coupling element and the guiding device.

Further developments of the method of the invention are discussed in the dependent method claims.

In accordance with a further embodiment of the invention, the method is further realized such that the optical component is adjusted relative to the resonator from a first position to a further position. This arrangement increases the lifetime of the optical component. It is thus possible to search for any desired undamaged or unused spot on the optical component and adjust it in the beam path of the resonator.

In a further embodiment of the invention, the position of the target surface of the primary laser radiation generated by the resonator on the optical component is changed by adjusting the optical component, but the direction of the beam path remains unchanged. According to this embodiment, it is not necessary to newly fine-adjust the optical component after an adjustment.

In a further embodiment of the invention, the method for adjusting an optical component in a device for generating laser radiation is realized such that the device for generating laser radiation comprises a sealed chamber in which the optical component to be adjusted is arranged. For being more easily accessible, the adjuster is arranged outside the sealed chamber, while the guiding device (e.g. a linear adjuster) is arranged within the sealed chamber.

The adjustment device for adjusting an optical component in a device for generating laser radiation comprises an intermediate element by means of which power is transmitted from the adjuster to the optical component. If the movement direction of the coupling element and the optical component and that of the intermediate element are not exactly parallel, there is a play in all three spatial axes, which is compensated for by the intermediate element.

In a further embodiment of the invention, the sealed chamber comprises an opening through which the power is transmitted from the adjuster to the optical component. This opening is sealed relative to the outer air in order to avoid contamination of the optical components arranged within the chamber.

In a further embodiment of the invention, the power is transmitted magnetically from the adjuster to the optical component through a wall of the chamber. An opening in the sealed chamber for adjusting the optical component is not necessary because of this arrangement. The adjustment is realized by the adjuster by the magnetic coupling of coupling element and intermediate element.

### BRIEF DESCRIPTION OF THE ACCOMPANYING DRAWINGS

Embodiments of the device according to the invention and the method according to the invention are shown in a schematically simplified manner in the drawings and will be discussed in more detail in the following description.

FIG. 1a shows a top view of the adjustment device in a device for generating laser radiation with two adjustment devices for adjusting the optical elements

FIG. 1b shows a side view of the adjustment device in a device for generating laser radiation with two adjustment devices for adjusting the optical elements

FIG. 2 shows a side view of the adjustment device in a device for generating laser radiation with magnetic power transmission through an opening in the chamber

FIG. 3 shows a side view of the adjustment device with magnetic power transmission through an opening in the chamber

FIG. 4 shows a side view of the adjustment device with intermediate element

FIG. 5 shows a view of the adjustment device with intermediate element

FIG. 6 shows a side view of the adjustment device with a coupling element with a ball-shaped surface

FIG. 7 shows a side view of the adjustment device for transmitting a rotational movement through the wall of the chamber

FIG. 8a shows a laser resonator with an internal adjustable optical assembly

FIG. 8b shows an adjustable optical assembly

### DETAILED DESCRIPTION

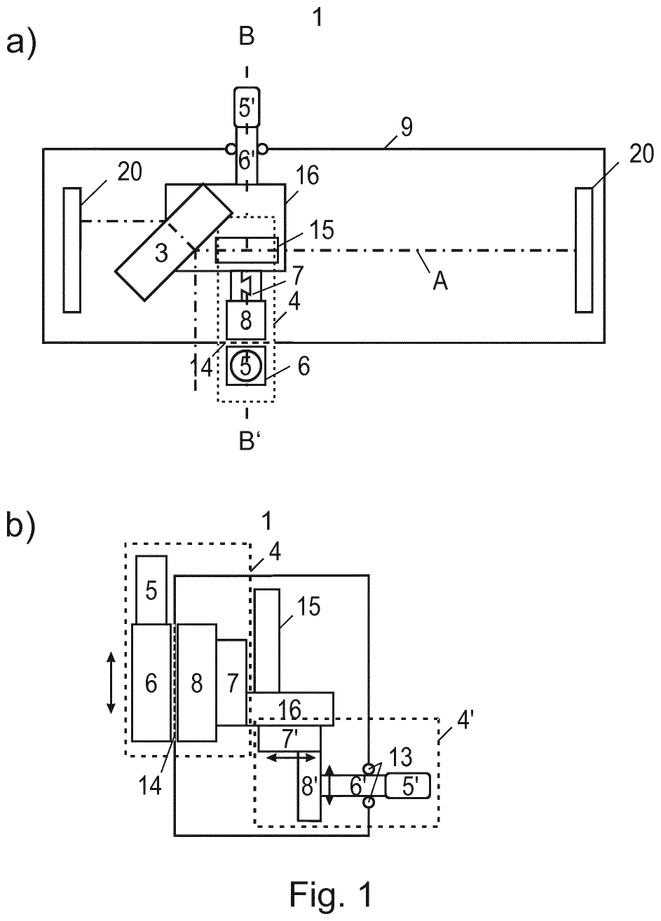

The device for generating laser radiation 1 in FIG. 1a and FIG. 1b comprises a resonator 2 generating a primary laser radiation and a frequency conversion device 15. The optical component 3 for deflecting the laser radiation is permanently connected to the adjustment device 4 by means of an adapter 16 and guided in the guiding device 7 of the adjustment device 4. The intermediate element 8 is arranged at the wall 14 of the chamber 9 in a manner adjustable parallel to the surface of the wall 14. The adjuster 5 is connected to the coupling element 6 outside the chamber 9. The power is transmitted magnetically between the coupling element 6 and the intermediate element 8. In this embodiment, the coupling element 6 comprises a magnetic material and is configured as a permanent magnet and the intermediate element 8 consists at least partially of a ferromagnetic material. The coupling element 6 and the intermediate element 8 are coupled by the magnetic attraction forces through the wall 14. Alternatively, also the intermediate element 8 can be configured as a magnet and the coupling element 6 can consist of the ferromagnetic material. Alternatively, it is also possible to use electromagnets. The adjustment device can be mechanical or motor-driven.

Furthermore, the adapter 16 is connected permanently to a second guiding device 7′. A second adjuster 5′ is connected to a second coupling element 6′ outside the chamber 9. Also in this case the power is transmitted magnetically between the second coupling element 6′ and a second intermediate element 8′. In the second adjustment device 4′, the second coupling element 6′ is configured as a permanent magnet and the second intermediate element 8′ in turn consists at least partially of a ferromagnetic material. The second coupling element 6′ is guided through an opening of the chamber 9. The gap between the chamber 9 and the second coupling element 6′ is sealed by means of a seal 13. The second coupling element 6′ is movably arranged at the second intermediate element 8′. When adjusting the optical components 3 by means of the first adjustment device 4, the second coupling element 6′ slides over the surface of the second intermediate element 8′, but still remains coupled thereto by the magnetic forces. Alternatively, also the use of electromagnets is possible. The adjustment device can be mechanical or motor-driven.

The optical component 3 can be a mirror, prism, a lens, an optically parametric oscillator (OPO) or a further frequency conversion device 15. A plurality of optical components 3 can be combined in an optical assembly and can be adjusted as a whole by means of the adjuster 5. The entire optical assembly is adjusted, an adjustment of individual optical components 3 as known in the prior art is not necessary. Therefore, the design and operation of the presented adjustment device 4 according to the invention are more cost-efficient, compacter and can be handled more easily. Moreover, fewer components are present in the chamber 9, which can discharge substances which can then in turn deposit on the optical components 3. In interaction with the laser radiation, in particular laser radiation in the UV range, these substances can also lead to a degradation of the optical component 3. This in the end leads to a reduction in the efficiency of the laser system.

For adjusting the optical component 3, the coupling element 6 is adjusted by an amount relative to the resonator 2 by means of the adjuster 5. In this embodiment, the adjustment is realized in the vertical direction. The intermediate element 8 is adjusted horizontally by the magnetic power transmission by the same amount as the optical component 3 is adjusted horizontally by the guiding device 7. The position of the reflected laser radiation A is not changed by the displacement, but the position of the laser spot X on the optical component 3 is changed. Thus, any desired undamaged or previously unused position on the optical component 3 can be selected as the target area of the laser radiation and positioned in the beam path of the resonator 2.

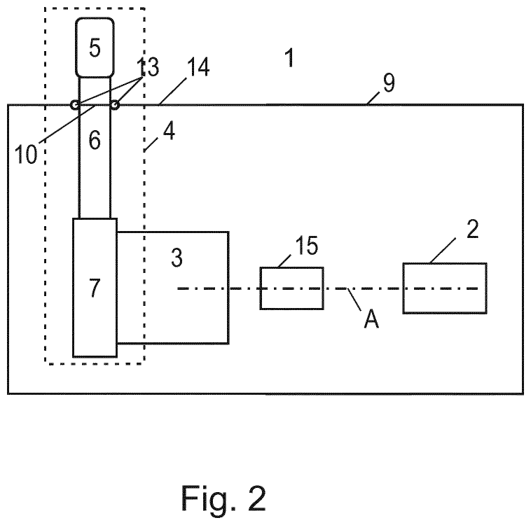

In FIG. 2 the adjustment device 4 is connected to the optical component 3 to be adjusted by means of an opening 10 in the chamber 9. The opening 10 comprises seals 13 for preventing the interior of the chamber 9 from dust and other contaminants from outside, which can decrease or increase the lifetime of the optical components 3 in the chamber 9. The primary laser radiation A generated by the resonator 2 is directed to the optical component 3 to be adjusted by the frequency conversion device 15. The optical component 3 is guided in the guiding device 7 which is magnetically connected to the coupling element 6. The coupling is realized by the coupling element that is configured as a magnet and by ferromagnetic material at the guiding device.

The coupling element 6 is adjusted by means of the adjuster 5. By the magnetic coupling of the coupling element 6 and the guiding device 7, at the same time the optical component 3 is adjusted. The sealed chamber 9 can be evacuated or flushed in order to minimize the number of dust particles and degassing products in the air. The seals 13 arranged in the opening 10 of the chamber 9 seal the spaces between the wall of the chamber 9 and the coupling element 6 guided through the opening 10 from external air.

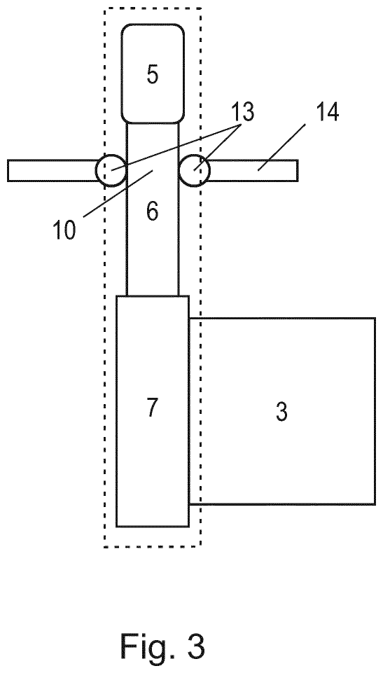

A detailed view of the adjustment device 4 according to the invention is shown in FIG. 3. The adjuster 5 is connected to the coupling element 6 which is magnetically connected to the guiding device 7 through a sealed opening 10 in the chamber 9. The optical component 3 to be adjusted is connected to the guiding device 7. In this case, an element of the guiding device 7 is configured as a magnet, while the coupling element 6 consists of a ferromagnetic material.

The coupling element 6 can be adjusted by means of a screw thread. In the simplest case, a manual adjustment is then possible. But also a motor-driven adjustment is conceivable. Then, the adjustment can also be controlled by a computer program and thus can be automated when the power of the laser system falls below a predetermined value. By the adjustor 5, the coupling element 6 is adjusted by an amount. The optical component 3 is adjusted by the same amount by the magnetic coupling of coupling element 6 and guiding device 7. In an alternative embodiment an optical component 3 is adjustable by means of two adjustment devices. In this manner, adjustment can be realized in two directions independently of one another and, for example, the entire surface of an optical component can be screened. The lifetime of the optical component 3 is thus increased considerably.

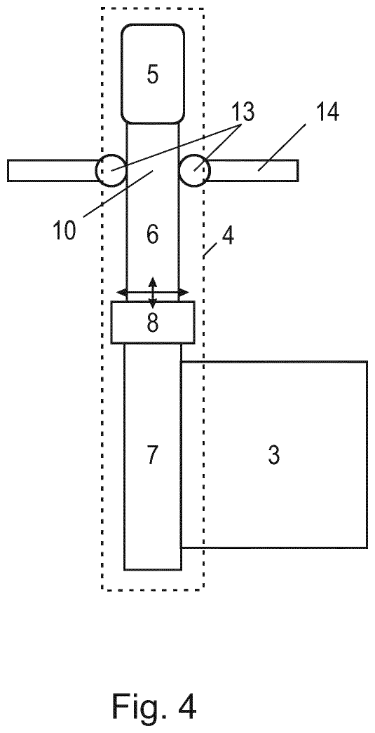

FIG. 4 shows an adjustment device 4 according to the invention with an intermediate element 8. The adjuster 5 is connected to the coupling element 6 which is magnetically coupled to the intermediate element 8 through a sealed opening 10 in the chamber 9. The intermediate element 8 is in turn magnetically coupled to the guiding device 7. This connection can alternatively also be permanent. In this embodiment of the invention, both the intermediate element 8 and the coupling element 6 are configured as magnets. The optical component 3 to be adjusted is guided in the guiding device 7. If the movement direction of the coupling element 6 and that of the optical component 3 guided in the guiding device 7 are not parallel, the intermediate element 8 allows for a certain play in all spatial axes in order to compensate for the offset of the two movement directions. Furthermore, fine-adjustment movements can be compensated for by the intermediate element 8. For example, if the coupling element 6 with the adjuster 5 is distorted by a small angle in the clockwise or counter-clockwise direction relative to the guiding device 7, the coupling element 6 moves laterally when the optical component 3 is adjusted in the vertical. The intermediate element 8 is thus adjusted parallel to the guiding device 7. By the magnetic coupling between coupling element 6, intermediate element 8 and guiding device 7, an adjustment in the vertical is guaranteed. This is the case, e.g., if the adjustment device 4 is retrofitted in an already existing device for generating laser radiation 1.

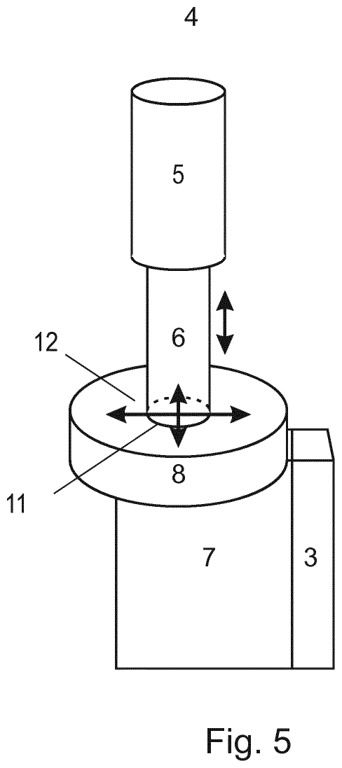

The mode of operation of the intermediate element 8 is shown more clearly in FIG. 5. The adjuster 5 is connected to the coupling element 6 which is magnetically coupled to the intermediate element 8. The intermediate element 8 is in turn coupled magnetically to the guiding device 7. The optical component 3 to be adjusted is guided in the guiding device 7. If the movement direction of the coupling element 6 and that of the optical component 3 guided in the guiding device 7 are not parallel, the non-permanent magnetic coupling between coupling element 6, intermediate element 8 and guide device 7 leads to a play which is compensated for by the intermediate element 8. When moving the optical component 3 in the vertical direction, the coupling element 6 moves to the side and slides on the contact surfaces 11, 12 of the coupling element 6 and the intermediate element 8. The intermediate element 8 itself is adjusted parallel to the optical component 3.

The magnetic coupling between coupling element 6, intermediate element 8 and guiding device 7 can be realized in that one of these three components 6, 7, 8 is a permanent magnet and the other two components 6, 7, 8 consist of a ferromagnetic material. In this connection it is irrelevant which of the three components 6, 7, 8 is the magnet. What is important is only a magnetic coupling of these three components 6, 7, 8. In this embodiment, the individual elements 5, 6, 8, 7 of the adjustment device 4 are coupled in that the coupling element 6 comprises a permanent magnet. By the magnetic field, the coupling element 6 is coupled to the intermediate element 8 consisting of a ferromagnetic material. By the magnetic field, at the same time the ferromagnetic material of the intermediate element 8 is magnetized. The intermediate element 8 magnetized in this manner in turn couples to the guiding device 7 by magnetic forces.

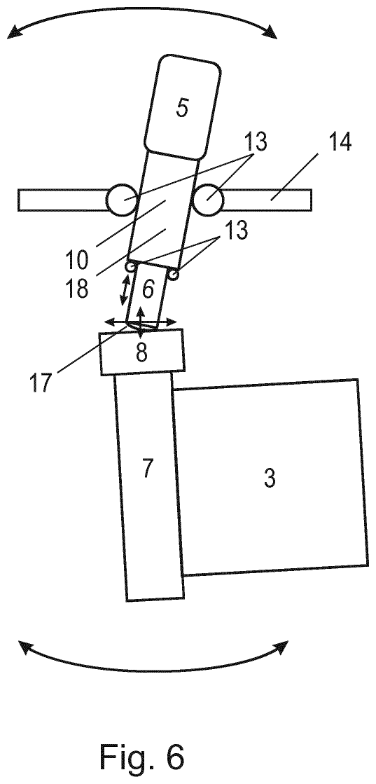

FIG. 6 shows an adjustment device 4 having a construction that is analog to that of the adjustment device of FIG. 4. The contact surface 17 of the coupling element 6 to the intermediate element 8 is ball-shaped in this embodiment. Thus, friction is reduced when the coupling element 6 slides across the contact surface of the intermediate element 8. Furthermore, the ball-shaped contact surface 17 of the coupling element 6 can compensate for rotational movements or also lateral movements of the intermediate element 8 and/or the adjustment device 4, which would lead to a tilting motion between coupling element 6 and intermediate element 8. Such a tilting motion can occur, e.g., when fine-adjusting the optical components 3. The ball-shaped surface 17 can also be arranged at the intermediate element 8, for example in that the intermediate element 8 is formed as a sphere. In a further alternative embodiment, the sliding movement between intermediate element 8 and coupling element 6 can also be omitted, because due to the possibility of tilting, slight lateral movements can also be compensated for without the contact between the coupling element 6 and the intermediate element 8 being interrupted.

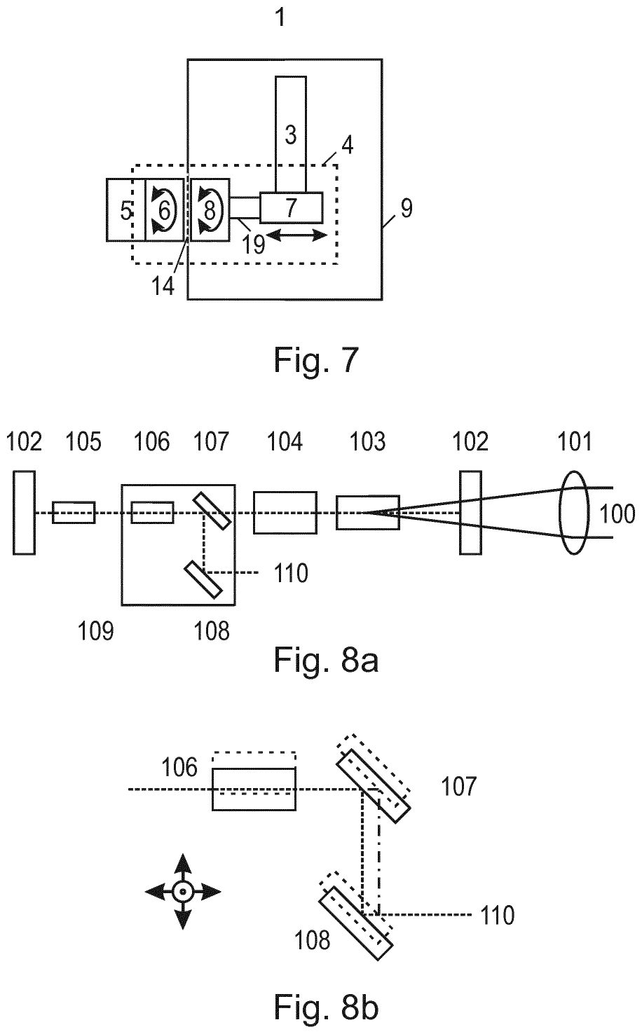

The device for generating laser radiation 1 of FIG. 7 comprises a resonator 2, which is not shown in the drawing and generates a primary laser radiation, and a frequency conversion device 15. The optical component 3 for deflecting the laser radiation is permanently connected to the adjustment device 4 by means of the guiding device 7 and guided therein. The intermediate element 8 is arranged at the wall 14 of the chamber 9 towards the surface of the wall 14, but is not permanently but adjustably connected to the wall 14. The adjuster 5 is connected to the coupling element 6 outside the chamber 9. The adjuster transmits a rotational movement to the coupling element. The power is transmitted magnetically between the coupling element 6 and the intermediate element 8, so that the intermediate element also makes a rotational movement. A linear adjuster 19 converts the rotational movement into a linear movement of the guiding element. The linear adjuster can comprise, e.g., a threaded rod. By the rotation of said threaded rod, a helical groove is moved linearly. In this embodiment, the coupling element 6 comprises a magnetic material and is configured as a permanent magnet, and the intermediate element 8 consists at least partly of a ferromagnetic material. The coupling element 6 and the intermediate element 8 are coupled by the magnetic attraction forces through the wall 14.

FIG. 8a shows a laser system in which a pump beam 100 is focused through a lens 101 onto the laser medium 103. The focused pump beam 100 passes through a resonator mirror 102 that is transparent to the wavelength of the pump beam 100 into the resonator of the laser system. In the laser medium 103, the coherent laser radiation 110 is generated by the pump radiation 100 preferably in the wavelength range of the UV light. The coherent laser beam 110 is guided by the laser medium 103 first through the quality switch (Q switch) 104. Through a mirror 107 that is transparent to selected wavelengths, the laser beam 110 reaches the frequency tripler 106 and the frequency doubler 105. From the second resonator mirror 102, the beam is reflected back into the beam path and divided at the mirror 107 that is transparent to selected wavelengths. Part of the laser beam penetrates the mirror 107 that is transparent to selected wavelengths and remains in the resonator. The laser beam converted by non-linear processes is separated by the mirror 107 that is transparent to selected wavelengths and decoupled from the resonator. A further deflection is made by the mirror 108.

In this embodiment, the adjustable optical assembly 109 comprises the frequency tripler 106, the separator mirror 107 that is transparent to selected wavelengths, and the mirror 108 (see FIG. 8b). This adjustable optical assembly 109 is arranged on a support element. By adjusting the support element, each individual element of the adjustable optical assembly 109 is moved by exactly the same distance as each other element of the adjustable optical assembly 109. In that the adjustable optical assembly 109 is adjusted as a whole, the laser beam 110 emanating from the resonator remains in the same position independent of the adjustment of the optical assembly 109. A crystal for generating the second harmonic can also be added to the assembly 109 as an embodiment.

### LIST OF REFERENCE SIGNS

1 device for generating laser radiation
2 resonator
3 optical assembly
4 adjustment device
5, 5′ adjuster
6,6′ coupling element
7 guiding device
8 intermediate element
9 chamber
10 opening
11, 12 contact surfaces
13 seal
14 wall
15 frequency conversion device
16 adapter
17 ball-shaped surface
18 connection piece
19 linear adjustment
20 mirror
100 pump beam
101 lens
102 resonator mirror
103 laser medium
104 Q switch
105 frequency doubler
106 frequency tripler
107 separator mirror
108 mirror
109 adjustable optical assembly
110 laser beam
A laser beam path before movement of the optical assembly
X laser spot

1. An adjustment device for adjusting an optical component in a device for generating laser radiation,
comprising an adjuster, a coupling element a guiding device,
wherein the coupling element is coupled to the adjuster and the guiding device,
wherein the guiding device is coupled to the optical component,
wherein the adjustment device is capable of changing the position of the optical component,
wherein two of the elements of the adjustment device are coupled by magnetic power transmission.

2. The adjustment device for adjusting an optical component in a device for generating laser radiation according to claim 1,
characterized in that
the device for generating laser radiation comprises a sealed chamber, wherein
the adjuster arranged outside the chamber and the guiding device is arranged inside the chamber and/or
wherein the two of the elements of the adjustment device are coupled by power transmission through a wall of the chamber.

3. The adjustment device for adjusting an optical component in a device for generating laser radiation according to claim 1,
characterized in that
the adjustment device comprises an intermediate element,
wherein the power transmission from the adjuster to the optical component is via the intermediate element.

4-20. (canceled)

21. The adjustment device for adjusting an optical component in a device for generating laser radiation according to claim 2,
characterized in that
the sealed chamber comprises an opening,
wherein an element of the adjustment device is guided through the opening of the chamber and/or
the adjustment device comprises a seal which seals the space between the element guided through the opening of the chamber and the edge of the opening.

22. The adjustment device for adjusting an optical component in a device for generating laser radiation according to claim 21,
characterized in that
the element of the adjustment device guided through the opening and the coupling element have contact surfaces by means of which the element of the adjustment device guided through the opening and the coupling element are connected.

23. The adjustment device for adjusting an optical component in a device for generating laser radiation according to claim 22,
characterized in that
the element of the adjustment device guided through the opening is connected in a laterally movable manner to the coupling element by means of the contact surfaces.

24. The adjustment device for adjusting an optical component in a device for generating laser radiation according to claim 23,
characterized in that
the diameter of the contact surfaces of the element of the adjustment device guided through the opening and that of the coupling element are different.

25. An adjustment device for adjusting an optical component in a device for generating laser radiation according to claim 1, comprising
a first adjustment device, configured to adjust the optical component in a first direction; and
a second adjustment device, configured to adjust the optical component in a second direction.

26. A device for generating laser radiation comprising
a resonator,
an optical assembly,
characterized in that
it comprises an adjustment device according to claim 1.

27. A method for adjusting an optical component in a device for generating laser radiation,
wherein the power is transmitted magnetically between two elements of an adjustment device according to claim 1.

28. The method for adjusting an optical component in a device for generating laser radiation according to claim 27,
characterized in that
the optical element is adjusted relative to a resonator from a first position to a second position.

29. The method for adjusting an optical component in a device for generating laser radiation according to claim 28,
characterized in that
by adjusting the optical component, the target surface of the laser radiation on the optical element is changed,
wherein the direction of the beam path of the laser radiation coming from the optical component remains unchanged by the adjustment of the optical component.
